(19) United States
(12) Patent Application Publication
(10) Pub. No.: US 2020/0291920 A1
(43) Pub. Date: Sep. 17, 2020

(54) High Yaw Error and Gust Ride Through

(71) Applicant: Mita-Teknik A/S, Rødkærsbro (DK)

(72) Inventors: Lars Risager, Ry (DK); Ole Stage Binderup, Silkeborg (DK)

(21) Appl. No.: 16/085,620

(22) PCT Filed: Mar. 17, 2017
(86) PCT No.: PCT/DK2017/050078

§ 371 Date: Sep. 17, 2018

(30) Foreign Application Priority Data
Mar. 18, 2016 (DK) PA 2016 70159

(51) Int. Cl. F03D 7/02; F03D 17/00

(52) U.S. Cl. CPC F03D 7/0224; F03D 17/00; F03D 7/0276; F05B 2270/328; F05B 2270/321; F05B 2270/32; F05B 2270/329; F05B 2270/327

(57) ABSTRACT

The present invention relates to a system adapted to reduce the load of a wind turbine in situations with high yaw error or by gust ride, which system has access to at least some operational parameters. The object is to reduce the maximal load of a wind turbine in situations where wind gust hits the wind turbine. The system can monitor at least a combination of these parameters, which system by a defined combination of at least some of actual parameters performs a pitch or speed regulation in order to bring the wind turbine into a safe mode of operation and reduce the load of the wind turbine. Hereby can be achieved that the system can monitor some of existing parameters for a wind turbine in operation and through these parameters it is possible with this system to perform an analysis of critical combinations of parameter values. In that way the system can react if a critical load exists because there is a critical combination of parameters and change the pitch of the blades towards the feathered position or by speed reduction.

### FIELD OF THE INVENTION

The present invention relates to a system adapted to reduce the load of a wind turbine in situations with high yaw error or by gust ride, which system comprises a tower carrying a yaw able nacelle, which nacelle carries at least one rotating pitch regulated blade, which system has access to at least the following parameters, wind speed, yaw error, rotor speed, pitch angle and power production.

### OBJECT OF THE INVENTION

The object of the pending patent application is to reduce the maximal loads of a wind turbine in situations where wind gust hits the wind turbine. A further object is to reduce the load in a situation with yaw error related to the wind gust ride through.

### DESCRIPTION OF THE INVENTION

In a preferred embodiment of the invention the system can monitor at least a combination of the parameters discloser in field of the invention, which system by a defined combination of at least some of actual parameters performs a pitch regulation whereby the average pitch angle is defined by a pitch angle limit vector and a corresponding wind speed vector whereby the yaw angle is defined by a yaw error limit vector and a corresponding wind speed vector in order to bring the wind turbine into a safe mode of operation and reduce the load of the wind turbine.

Hereby can be achieved that the system can monitor a lot of existing parameters for a wind turbine in operation and throw these parameters it is possible with this system to perform an analysis of critical combinations of parameter values. In that way the system can react if a critical load exists because there is a critical combination of parameters. Even in situations where each single parameter value is still within a limit that is defined for the wind turbine. Therefore, this system is highly effective if it is installed in existing wind turbines and in newly developed wind turbines. Through this system it is possible in critical situations, by regulation of the pitch, to reduce the power production without performing a total shut down. Therefore, the power production will probably be slightly reduced when the system starts to control the pitch of the blades. But in many situations the load of the blade is maybe so high that a reduction in the pitch position towards the wind will only reduce the power production with a few percent and in that situation reduce the mechanical load of the wind turbine into a safe value of operation. The overall idea is to activate a safe mode when either rapid wind speed increase in combination with some yaw error increase or high wind speed in combination with high yaw error is observed to reduce extreme loading at the turbine. It is not only pitch regulation that brings the turbine into safe mode but also rotor speed reduction and power reduction which is related to pitch regulation.

In a further preferred embodiment of the invention the safe mode operating can be activated by the following conditions:

a. rotor acceleration is higher than a specified parameter value,

b. the average pitch angle for all blades is less than a specified value at the given wind speed,

c. the yaw error is higher than a specified value at the given wind speed.

Hereby at least these three parameters can be monitored and compared with specified parameter values. In some situations only a combination of these three parameters will lead to a load situation of the wind turbine that is critical. In critical situations where for example the yaw error in relation to the actual wind gust is rather high, maybe up to 90°, a critical situation could occur even if for example rotor acceleration is within the limitation and pitch angle for blades is within the specified values for the wind speed but the direction of the wind is critical and it is necessary suddenly to reduce the pitch angle in order to reduce the total load of the wind turbine in order to prevent overload of the tower.

In a further preferred embodiment of the invention the average pitch angle can be defined by a pitch angle limit vector and a corresponding wind speed vector. Hereby can be achieved that the wind turbine uses existing limiting vectors in combination with wind speed vector as one of the parameters. Hereby can be achieved that an existing pitch angle limit vector, which corresponds to a wind speed vector, is to be used in order to reduce the load of the wind turbine by adjusting the pitch regulation of the blades towards a feathered position.

In a further preferred embodiment of the invention the yaw angle can be defined by a yaw error limit vector and a corresponding wind speed vector. Hereby can be achieved that at low wind speed the yaw error limiting vector can have a larger value than in situations where wind speed is much higher.

In a further preferred embodiment of the invention safe mode of operating can be activated by the following conditions:

a. the average pitch angle (18) for all blades is less than a specified value at the given wind speed,

b. the yaw error is higher than a specified value at the given wind speed. Hereby, a situation can occur where a combination of pitch angle and wind speed can result in a necessary reduction of the pitch angle in order to reduce the total load on the wind turbine maybe in order to protect the tower from any overload.

In a further preferred embodiment of the invention the average pitch angle can be defined by a pitch angle limit vector and a corresponding wind speed vector. Hereby can be achieved that there is a well-known defined relation between pitch angle and wind speed. These data can in a system be contained in a software database where the relation between different parameters is defined.

In a further preferred embodiment of the invention the can wind direction angle relative to nacelle direction be defined by a yaw error limit vector and a corresponding wind speed vector. Hereby is achieved that also data segments representing the relation between pitch angle and wind speed is defined as for example rows in a software routine where different limitations are also stored. Hereby can be achieved that a relation between yaw error and wind speed can be stored in the computer system, whereby it is possible to define critical wind speeds related to yaw error. This can be important in situations where wind direction is jumping rapidly, for example in critical situations where heavy rain showers are approaching the wind turbine. Heavy showers of rain or thunder can lead to a rapid change in the wind direction. In these situations it can be rather important to reduce the pitch angle towards the feathered position in order to avoid any overload of nacelle or tower.

In a further preferred embodiment of the invention, the condition as previously disclosed has not been fulfilled in a specified period power reference and rotor speed reference are ramped up to normal operation values allowing the wind turbine to operate normally. Hereby can be achieved that in situations where a partial shutdown through pitch regulation towards a feathered position, which has led to a reduction in the power production where the conditions are normalised and have been normalised for a period, the system will start to slowly adjust the pitch towards the normal situation and hereby the wind turbine will start normal optimal production of power.

In a further preferred embodiment of the invention a method to reduce the load of a wind turbine in situations with high yaw error or by gust is disclosed, where at least the following operational parameters are monitored:
wind speed,
yaw error,
rotor speed,
pitch angle,
power production,

by which method analysis of defined combinations of at least some of the actual parameters, which method performs a pitch regulation in order to bring the wind turbine into a safe mode of operation and thereby reduce the load of the wind turbine.

Hereby can be achieved that the system uses existing parameters in a controlled system for a wind turbine. By this method it is possible for the system to analyse different combinations of measured parameters in order to perform a pitch regulation towards feathered position by any critical combination of parameters as disclosed.

In a further preferred embodiment of the invention the method can compare actual parameters with defined limits for the parameters

a. rotor acceleration is higher than a specified parameter value, at a given wind speed

b. the average pitch angle for all blades is smaller than a specified value at the given wind speed,

c. the yaw error is higher than a specified value at the given wind speed,

which method performs a pitch regulation in order to reduce the load of the wind turbine. Hereby can be achieved that a combination of these parameters can fulfil the necessary conditions for a reduction of the pitch for reducing the total load of the wind turbine.

In a further preferred embodiment for the invention the method can compare actual parameters with defined limits for the parameters:

a. the average pitch angle for all blades is smaller than a specified value at the given wind speed,

b. the yaw error is higher than a specified value at he given wind speed,

which method performs a pitch regulation in order to reduce the load at the wind turbine.

Hereby can be achieved that a combination of the a and b parameters can be used for pitch regulation and hereby reduce the load of the wind turbine and maybe hereby also protect the tower from any overload. The safe mode is obtained via two things:
1) Pitch towards feather/stop
2) The rotor speed is reduced

Actually also power is reduced but this is related to 1)

Often the design of wind turbines results in driving extreme loads on blades, nacelle and tower when a wind gust or a wind gust in combination with a wind direction change happens. A control feature to reduce these extreme loads at these conditions has been developed. The algorithm is described in the next section.

The overall purpose of the control feature called “High Yaw Error and Gust Ride Through” in the following referred to as “HYEGRT” is to reduce extreme loads at a wind turbine exposed to a wind gust or a wind gust in combination with a wind direction change while at the same time ensuring that the power production loss caused by the feature is minimal.

The overall idea is to activate a HYEGRT safemode when either rapid wind speed increase in combination with some yaw error increase or high wind speed in combination with high yaw error is observed to reduce extreme loading at the turbine. Pitch regulation is in some situation combined with a torque regulation of the generator. The power production is increased and the acceleration of the rotor is reduced.

The following measurements are needed as inputs for the control feature:
Wind speed
Yaw error
Rotor speed
Pitch angle(s)
Power

When the HYEGRT safemode is activated the following happens:
A fast pitch towards stop/feather sequence is activated
The rotor speed reference is reduced
The power reference is reduced

The HYEGRT safemode is activated when one of the two conditions are fulfilled:

Condition 1:
Rotor acceleration is higher than a specified parameter value
The average pitch angle for all blades is less than a specified value (given via a pitch angle limit vector and a corresponding wind speed vector) at the given wind speed
The yaw error is higher than a specified value (given via a yaw error limit vector and a corresponding wind speed vector) at the given wind speed

Condition 2:
The average pitch angle for all blades is less than a specified value (given via a pitch angle limit vector and a corresponding wind speed vector) at the given wind speed
The yaw error is higher than a specified value given via a yaw error limit vector and a corresponding wind speed vector) at the given wind speed

When conditions 1 and 2 have not been fulfilled in a specified period, power reference and rotor speed reference are ramped up to normal operation values allowing the turbine to run normally.

### DESCRIPTION OF THE DRAWING

FIG. 1 shows a wind turbine.

FIG. 2 shows a table of parameters.

### DETAILED DESCRIPTION OF THE INVENTION

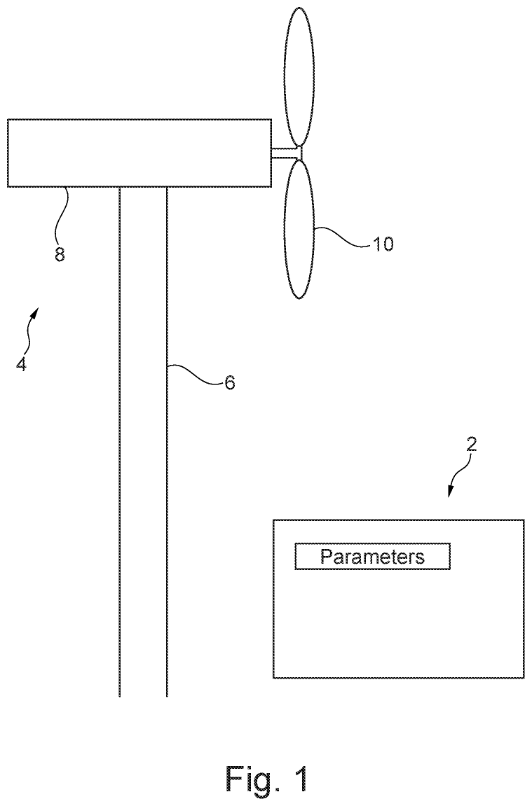

FIG. 1 shows a wind turbine 4 and a system 2 in order to control high yaw error and gust ride through of the wind turbine 4. The turbine 4 comprises a tower 6, a nacelle 8 and blades 10. Not shown in the figure is gear and one or more generators placed in the nacelle 8. The system 2 for control of high yaw error and gust ride through comprises a list of parameters. Based on analysis of these actual measured parameters the system is able to perform pitch or speed regulation in order to reduce the load on the tower 6, blades 10 or nacelle 8, if one of the parameters or a combination of the parameters has come into a critical combination. By reducing the power production in critical situations the maximal load on blade, nacelle and tower is limited so the stress of the components is probably reduced. This can lead to higher reliability and a much longer lifetime of the tower and nacelle, maybe also the blades. Further it can be used to reduce the amount of material in structural components like blades and tower as the loads are reduced. The benefit is mainly to reduce the amount of material in blades and tower etc.

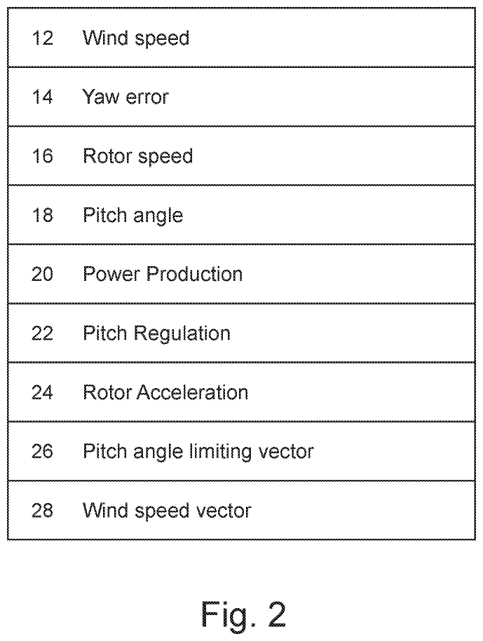

FIG. 2 discloses a table of the different parameters that are in use for controlling the wind turbine 4. Wind speed measurement is probably performed by a rotating wind measuring device which is often placed on the nacelle. The wind speed as such has a. defined area of operation. At very low wind speed, maybe less than 2 metres per second, a switch off of the system is probably performed because the wind speed will give less power than what the system as such is using. In the other end, at maximum wind speed, a reduction of the pitch angle will probably be performed if wind speeds exceed maybe 15 metres per second whereas at wind speed above 25 metres per second the wind turbine will be totally switched off. The yaw error 14 is an error that occurs if the direction of the wind changes. For continuous change in wind the yaw position of the nacelle will be adjusted. In situations where wind gust ride through exists, it is possible that the direction of the wind is changing rapidly. Here the yaw error will be increased to a relatively high value. The rotor speed 16 is of course a typically measured parameter in a wind turbine. The rotor speed probably also has a minimum and a maximum speed which are acceptable. Because a generator is directly coupled to the rotor speed by gear or directly coupled, the frequency of generated power will therefore probably be related to the rotor speed. But because the wind turbine probably comprises an inverter system the power is at first converted to direct current and afterwards into AC3 phased power with the correct frequency. Because the system is using the inverter technology, a relatively high span of rotor speed can be accepted.

The pitch angle 18 is adjusted for higher wind speed in order to reduce the power production of the wind turbine. Up to a certain wind speed the pitch will be regulated for maximal yield and after a certain limit, a gradual downwards regulation towards a feathered position will be performed.

Power production 20 is of course also a relatively important parameter that is measured. By the system as disclosed previously in this patent application, power production is by this system reduced in order to reduce the maximum load of the wind turbine.

Pitch regulation 22 the wind turbine comprises a pitch regulation system. This regulation system could be performed by electric motors or it could be produced by hydraulic devices.

Rotor acceleration 24 one of the more important parameters to be measured is situations where a rapid acceleration of the rotor takes place. Rotor acceleration can indicate wind gust just as effectively as maybe the wind speed sensor. Therefore, rotor acceleration is, for a fast operating system, rather important to be controlled. Pitch angle limit vector 26 is a limiting vector which is performed as a table based on wind speed and pitch angle. The system as such comprises a table where the two values are related to each other.

Wind speed vector 28 is simply a vector that is defined based on measuring of the wind speed.

A system for high yaw error and gust ride through load reduction can of course comprise further parameters as disclosed in the table shown in FIG. 2. The system as such is not limited to use all the defined parameters but in some situations full control of the system could be performed by only using some of the defined parameters.

Definition:

Wind direction: Actual wind direction

Yaw angle: Actual yaw position of the nacelle

Relative wind direction to nacelle direction: Actual wind direction measured at the nacelle defines the Yaw error.

### REFERENCE NUMERALS

System (2)

wind turbine (4)

tower (6)

nacelle (8)

blade (10)

wind speed (12)

yaw error (14)

rotor speed (16)

pitch angle (18)

power production (20)

pitch regulation (22)

rotor acceleration (24)

pitch angle limit vector (26)

wind speed vector (28).

1. System (2) adapted to reduce the load of a wind turbine (4) in situations with high yaw error in combination with gust, which system (2) comprising a tower (6) carrying a yaw able nacelle (8), which nacelle (8) carries at least one rotating pitch regulated blade (10), which system (2) has access to at least the following parameters, wind speed (12), yaw error (14), rotor speed (16), pitch angle (18) and power production (20), wherein the system (2) monitors at least a combination of these parameters (12,14,16,18,20), which system by defined combination of at least some of actual parameters (12,14,16,18,20) performs a pitch regulation (22) whereby the average pitch angle (18) is defined by a pitch angle limit vector (26) and a corresponding wind speed vector (28), whereby the yaw angle is defined by a yaw error (14) limit vector and a corresponding wind speed vector (28), in order to bring the wind turbine (4) into a safe mode of operation and reduce the load of the wind turbine (4).

2. System according to claim 1, wherein the safe mode of operating is activated by the following conditions:
a. rotor acceleration (24) is higher than a specified parameter value, and
b. the average pitch angle (18) for all blades is less than a specified value at the given wind speed (12), and
c. the yaw error (14) is higher than a specified value at the given wind speed (12).

3. System according to claim 1, wherein the safe mode of operating is activated by the following conditions:
a. the average pitch angle (18) for all blades (10) is smaller than a specified value at the given wind speed (12), and
b. the yaw error (14) is higher than a specified value at the given wind speed (12).

4. System according to claim 3, wherein the average pitch angle (18) is defined by a pitch angle limit vector (26) and a corresponding wind speed vector (28).

5. System according to claim 3, wherein
the yaw angle is defined by a yaw error (14) limit vector and a corresponding wind speed vector (28).

6. System according to claim 1, wherein when conditions:
a. rotor acceleration (24) is higher than a specified parameter value, and
b. the average pitch angle (18) for all blades is less than a specified value at the given wind speed (12), and
c. the yaw error (14) is higher than a specified value at the given wind speed (12) have not been fulfilled in a specified period, power reference and rotor speed reference are ramped up to normal operation values allowing the wind turbine (4) to operate normally.

7. Method to reduce the load of a wind turbine (4) in situations with high yaw error or by gust as disclosed in claim 1 wherein the following operational parameters are monitored:
wind speed (12),
yaw error (14),
rotor speed (16),
pitch angle (18),
power production (20),
by which method analysis of a defined combination of at least some of the actual parameters (12,14,16,18,20),
which method performs a pitch regulation (22) in order to bring the wind turbine (4) into a safe mode of operation and thereby reduce the load of the wind turbine (4).

8. Method according to claim 7, wherein the method compares actual parameters with defined limits for the parameters:
a. rotor acceleration (24) is higher than a specified parameter value, and
b. the average pitch angle (18) for all blades (10) is less than a specified value at the given wind speed (12), and
c. the yaw error (14) is higher than a specified value at the given wind speed (12), which method performs a pitch regulation in order to reduce the load on the wind turbine (4).

9. Method according to claim 7, wherein the method compares actual parameters with defined limits for the parameters:
a. the average pitch angle (18) for all blades (10) is less than a specified value at the given wind speed (12), and
b. the yaw error (14) is higher than a specified value at the given wind speed (12), which method performs a pitch regulation in order to reduce the load on the wind turbine (4).
